(19) United States
(12) Patent Application Publication
(10) Pub. No.: US 2017/0336760 A1
(43) Pub. Date: Nov. 23, 2017

(54) Movement for a Timepiece Comprising an Annular Module

(71) Applicant: C.H. Meylan S.A., Le Brassus (CH)

(72) Inventor: David Candaux, Le Solliat (CH)

(21) Appl. No.: 15/508,252

(22) PCT Filed: Sep. 2, 2015
(86) PCT No.: PCT/IB2015/001506

§ 371 Date: Jul. 20, 2017

(30) Foreign Application Priority Data
Sep. 2, 2014 (CH) 01329/14

(51) Int. Cl. G04B 19/28

(52) U.S. Cl. CPC G04B 19/283

(57) ABSTRACT

A movement for a timepiece comprises a plate (1) and an annular module (2) circumferentially surrounding the plate (1). The module (2) comprises a mobile ring (2″) mounted so as to be made to rotate about its axis by a rolling means, the mobile ring (2″) carrying a rotary indicator (3). The rotary indicator (3) is an attachment, of which a first part (3A) fixed to a crown (5) arranged on the mobile ring (2″) is flat and parallel to a plane defined by the crown (5) and a second part (3B) is a protruding curved part. The second part (3B), in the shape of a tip, is oriented towards the centre of the crown (5), the crown (5) comprising a housing for receiving one end of the first part (3A) of the rotary indicator (3). The movement further comprises a drive train (4) for driving the mobile ring (2″) in rotation at a speed of rotation imparted by the timepiece movement, such that, when it is driven around the periphery of the plate (1), the rotary indicator (3) displays time information indicating hours, minutes or seconds.

The present invention relates to a movement for a timepiece comprising an annular module to indicate an item of time information.

In mechanical watches and clocks, time indications are generally displayed using hands or rings or discs rotated behind an aperture in a dial.

However, there is a constant need for alternative display forms, in particular making it possible to break with conventional aesthetic codes.

Thus for example, EP 2,478,419 is known, which describes a bracelet watch comprising a channel through a glass, arranged such that a fluid moved by a pump reaches the channel, so as to successively color different portions of said glass in order to display time indications. This hydraulic circuit surrounds the dial and therefore makes it possible to read the time peripherally.

CH 705,806 describes a watch displaying the hours and minutes in an original manner, owing to a peripheral driving of 12 pairs of hands on the perimeter of the dial. The 12 bearing blocks distributed around the dial each bear a long hand to indicate the 5 minute pitches and a short hand for the hours. The first rotates around its axis, and the second gravitates around the first to appear above it or hide behind it. Each hand is connected to a driving wheel and has a blue face when it displays the time, a neutral face when it is not moving. The hands are driven by two crowns rotating around the dial. Both have toothed sections that mesh with the driving wheels of the hands at each bearing block.

The aim of the present invention is to create timepieces comprising an annular module to indicate an item of time information in an original manner.

According to the invention, a mechanical movement for a timepiece comprises a plate and an annular module circumferentially surrounding the plate. The module comprises a moving ring mounted to be rotated around its axis by a rolling means, the moving ring bearing a rotary indicator. The rotary indicator is an attached part, a first portion of which fastened to a crown arranged on the moving ring is flat and parallel to a plane defined by the crown and a second protruding and curved part. The second portion, in the form of a point, is oriented toward the center of the crown (5), the crown (5) comprising a housing for receiving one end of the first part (3A) of the rotary indicator (3). The movement further comprises a driving gear train arranged to rotate the moving ring with a rotation speed imparted by the clockwork movement, such that when it is driven around the periphery of the plate, the rotary indicator displays an item of time information for the hours, minutes or seconds.

Such a movement may be used both for a mechanical watch and a quartz watch.

In one embodiment, the movement comprises a module comprising at least two superimposed coaxial rings kept spaced apart from one another, the first coaxial ring being secured to the plate, the second being movable and bearing the indicator of an item of time information.

According to the latter embodiment, the module may comprise beads positioned between the two superimposed coaxial rings so as to form a ball bearing.

In another embodiment, the moving ring can be arranged in a groove arranged in the middle of the watch case, in which groove the moving ring will be able to slide, driven by means.

Preferably, the moving ring can comprise a toothing for example arranged on an inner edge of the ring, to be driven by an intermediate train of the movement. The driving of the rotary indicator can be continuous or intermittent, for example from second to second, or by hops by second plateaus.

The features of the invention will appear more clearly upon reading the description of several embodiments provided solely as an example, non-limitingly in reference to the schematic figures, in which:

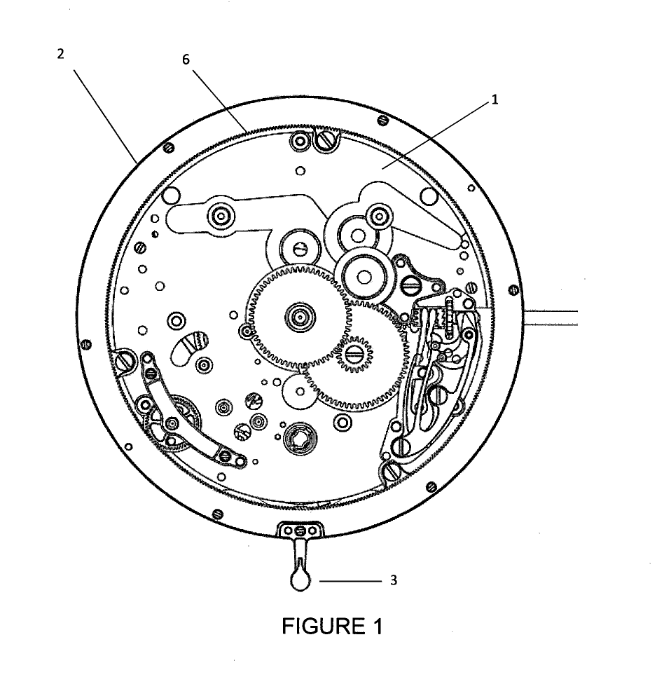

FIG. 1 shows a front view of a movement provided with an annular module bearing an index at 6 o'clock;

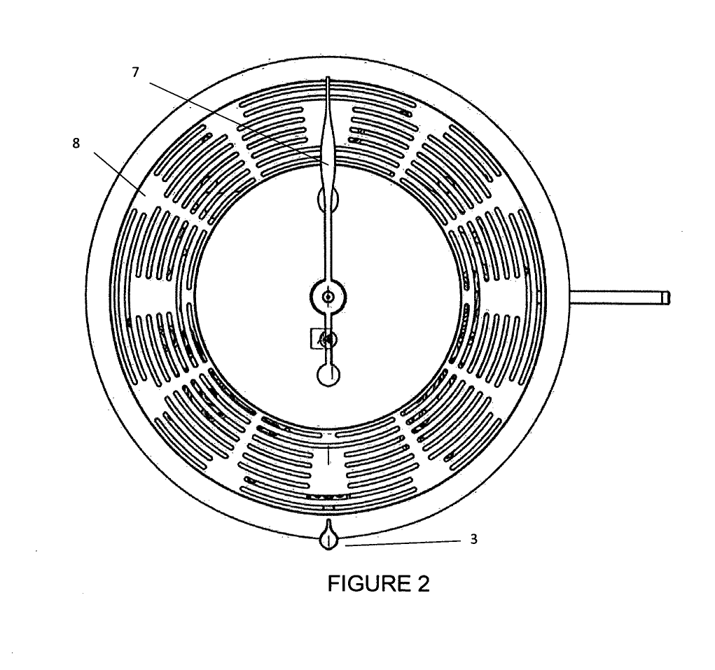

FIG. 2 shows a front view of a movement provided with an annular module bearing an index at 6 o'clock, the movement being provided with hands shown in their position at 12 o'clock and a dial covering the movement and the annular module;

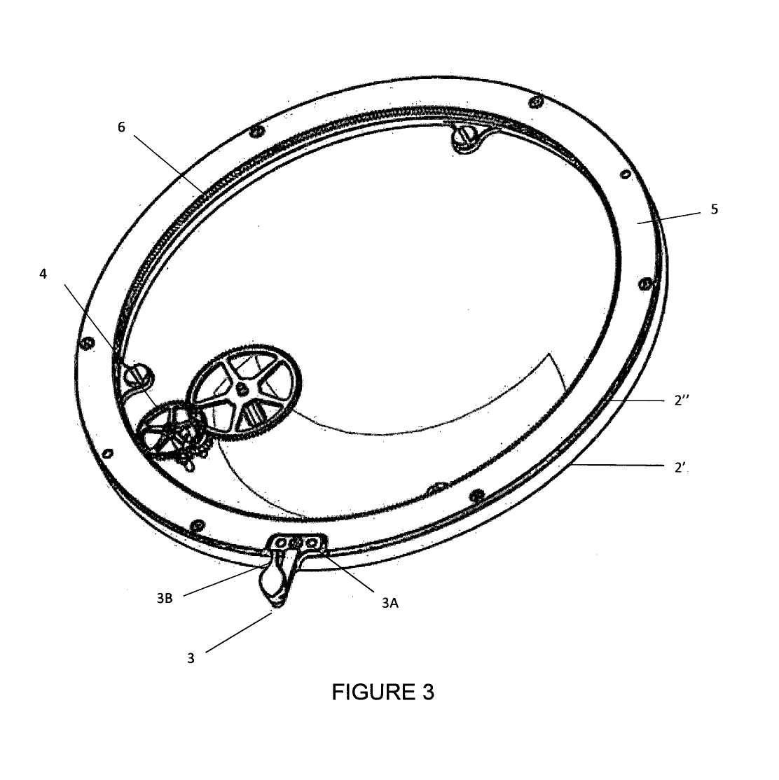

FIG. 3 shows a perspective view of an annular module comprising a crown mounted on a ball bearing, the crown bearing an index and being driven by a gear train;

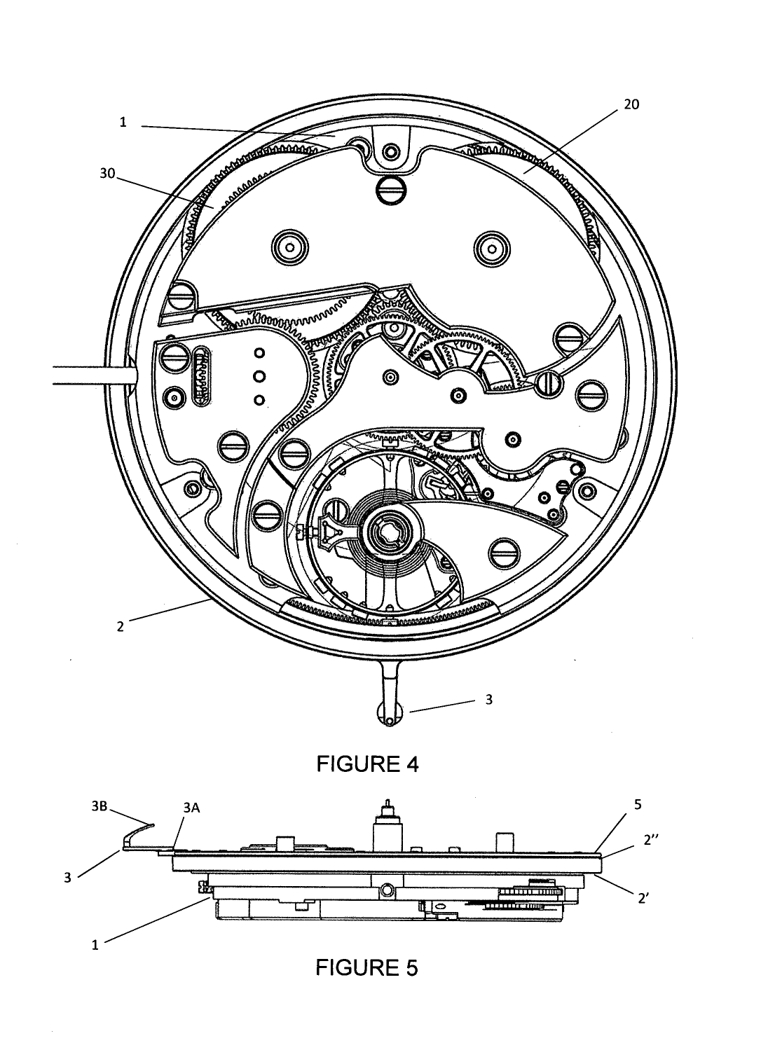

FIG. 4 shows a rear view of the movement provided with an annular module of FIG. 1;

FIG. 5 shows a side view of the movement provided with an annular module of FIG. 1; and

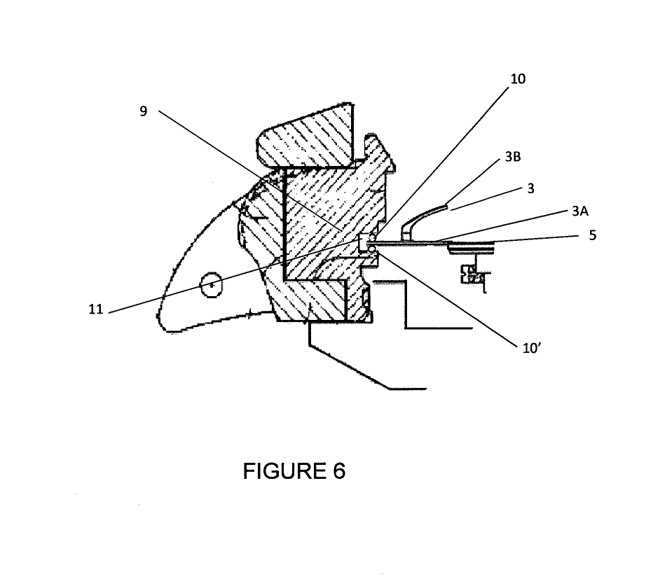

FIG. 6 shows a partial sectional view of the movement provided with an annular module positioned in a groove of a watch case middle.

The following description relates to a mechanical movement, the seconds display of which is peripheral to the dial. As illustrated in FIG. 1, the movement comprises a plate 1 and an annular module 2 circumferentially surrounding the plate 1. The module 2 comprises a moving ring mounted to be rotated around its axis by a rolling means. The moving ring bears the rotary indicator 3 of the seconds.

In the example illustrated in FIG. 2, the indication of the hours and minutes is at the center of the movement, and the hours and minutes are displayed by hands 7. The indicator 3 of the seconds is peripheral, and when a watch dial 8 is mounted, only the peripheral indicator of the seconds 3 and the hands 7 are visible. Preferably, the dial 8 can bear miscellaneous indications, for example numbers, divisions, or indexes.

As illustrated in FIG. 3, the module 2 comprises two superimposed coaxial rings 2′, 2″ kept spaced apart from one another, in this example by balls, the first coaxial ring 2′ being secured to the plate 1, the second 2″ being movable. A toothed crown 5 bearing an indicator 3 of the seconds that will mesh directly with an intermediate seconds train 4 of the movement is added on this ball bearing. The moving ring 2″ is fastened, in the case at hand, to a crown 5 comprising a toothing 6, on an inner edge, arranged to be driven by an intermediate seconds train 4.

The superposition of the crown 5 and the two superimposed coaxial rings 2′, 2″ kept spaced apart from one another is illustrated in FIG. 3. The indicator member 3 is a part whereof a first portion fastened to the crown 5 is flat and parallel to a plane defined by the crown 5 and a second protruding and curved part constitutes a point oriented toward the center of the crown 5.

The intermediate seconds train 4 rotates the toothed crown 5 such that the indicator 3 indicates the current seconds when the toothed crown 5 is rotated by the train 4. The second is indicated on the periphery of the movement. The moving crown 5 is driven by the intermediate seconds train 4 at a speed of one revolution per minute, and the indicator 3 thus indicates the seconds.

As illustrated in FIG. 6, the movement comprises a ring 2″, guided outside by rolling means, said ring 2″ being movable and bearing an index 3 indicating an item of time information. The moving ring 2″ is surrounded by the case middle 9 of the watch, an outer end of the first part 3A of the indicator member is inserted in a circumferential groove 11 of the case middle 9 with rolling means 10, 10′ on either side of the outer end of the first part 3A in the groove 11. The moving ring inserted in the groove 11 of the watch case middle 9 and the rolling means 10, 10′ not only ensure that it is kept in position, but also see to its circular movement. The rolling means 10, 10′ can for example be balls partially integrated into the groove 11 or balls integrated into the moving ring. In another embodiment, the rolling means 10, 10′ can be rings.

As illustrated in FIG. 4, this mounting of a circumferential module makes it possible to retain access to the entire plate, in particular to integrate any sort of display or complication while retaining this peripheral display. In this example, the mechanical movement comprises two barrels 20, 30 mounted in series offering a power reserve of three days. Each of the barrels 20, 30 is off-centered relative to the center of the movement. The barrels 20, 30 rotate the moving ring 2″. The indication of the hours and minutes is at the center of the mechanical movement, while the indication of the second is indicated on the periphery of the movement and mounted on a ball bearing. A winding-crown stem is positioned at 3 o'clock.

In the illustrated examples, the toothing 6 of the moving ring is internal, but in one alternative, it may be external.

Depending on the type of peripheral module used, i.e., whether it involves a single moving ring, a double ring, one ring being movable and the other being fastened to the plate, or a component serving as support and for rotation for a crown such as a ball bearing on which the crown is fastened, the thickness of the movement considered on the outside may vary from 3 to 7 millimeters, for example 5 millimeters. Independently of the thickness, the movement may be adapted to different diameters comprised between 26 millimeters and 34 millimeters, for example 30 millimeters.

1. A mechanical movement for a timepiece comprising a plate, an annular module circumferentially surrounding the plate, the module comprising a moving ring mounted to be rotated around its axis by a rolling means, the moving ring bearing a rotary indicator, the rotary indicator being an attached part, a first portion of which fastened to a crown arranged on the moving ring is flat and parallel to a plane defined by the crown and a second protruding and curved part, said second portion, in the form of a point, being oriented toward the center of the crown, the crown comprising a housing for receiving one end of the first part of the rotary indicator, the movement further comprising a driving gear train arranged to rotate the moving ring with a rotation speed imparted by the clockwork movement, such that when it is driven around the periphery of the plate, the rotary indicator displays an item of time information for the hours, minutes or seconds.

2. The movement according to claim 1, comprising a module comprising at least two superimposed coaxial rings kept spaced apart from one another, the first coaxial ring being secured to the plate, the second being movable and bearing the indicator of an item of time information.

3. The movement according to claim 1, wherein the module comprises beads positioned between the two superimposed coaxial rings so as to form a ball bearing.

4. The movement according to claim 3, wherein the moving ring comprises a toothing arranged to be driven by an intermediate train of the movement.

5. The movement according to claim 1, wherein the crown comprises a toothing arranged to be driven by an intermediate train of the movement.

6. The movement according to claim 4, wherein the toothing is arranged on an inner edge of the moving ring or the crown.

7. The movement according to claim 1, wherein the moving ring is arranged to be driven by an intermediate seconds train at a speed of one revolution per minute, and the indicator indicates the seconds.

8. The movement according to claim 1, comprising a display of the hours and minutes inside the space surrounded by the annular module.

9. The movement according to claim 8, wherein the display of the hours and minutes comprises hands.

10. The movement according to claim 1, whereof the diameter considered on the outside of the annular module is comprised between 26 millimeters and 34 millimeters and the thickness is comprised between 3 millimeters and 7 millimeters.

11. The movement according to claim 1, wherein the moving ring is surrounded by the case middle of the watch, an outer end of the first part of the indicator member is inserted in a circumferential groove of the case middle with rolling means on either side of the outer end of the first part in the groove.

12. The movement according to claim 1, wherein the moving ring is rotated by at least one barrel, the center of which is off-centered relative to the center of the movement.

13. A timepiece comprising a movement according to preceding claim 1.

14. The movement according to claim 2, wherein the module comprises beads positioned between the two superimposed coaxial rings so as to form a ball bearing.

15. The movement according to claim 2, wherein the crown comprises a toothing arranged to be driven by an intermediate train of the movement.

16. The movement according to claim 3, wherein the crown comprises a toothing arranged to be driven by an intermediate train of the movement.

17. The movement according to claim 5, wherein the toothing is arranged on an inner edge of the moving ring or the crown.
